(19) United States
(12) Patent Application Publication
(10) Pub. No.: US 2014/0136400 A1
(43) Pub. Date: May 15, 2014

(54) SYSTEM FOR THE OPTIMIZATION OF THE CREDIT CARD DECISION PROCESS

(71) Applicants: John R. Espey, III, Charlotte, NC (US); Christopher T. Hart, Pineville, NC (US)

(72) Inventors: John R. Espey, III, Charlotte, NC (US); Christopher T. Hart, Pineville, NC (US)

(21) Appl. No.: 14/078,457

(22) Filed: Nov. 12, 2013

Related U.S. Application Data
(60) Provisional application No. 61/725,066, filed on Nov. 12, 2012.

(51) Int. Cl. G06Q 20/22

(52) U.S. Cl. CPC G06Q 20/22
USPC 705/39

(57) ABSTRACT

A system and method of recommending a preferred payment method for individual transactions may include a software program. A user may set up an account and input personal information, payment information and store information for a potential purchase. A server database may store the inputted information. The user may select a store choice and receive an estimate of a purchase amount. The user may receive recommended payment method based at least on the purchase amount, the payment information, user preferences and the store information.

### CROSS-REFERENCE TO RELATED APPLICATION

This application claims the benefit of U.S. provisional application No. 61/725,066, filed Nov. 12, 2012, the contents of which are herein incorporated by reference.

### BACKGROUND OF THE INVENTION

The present invention relates to a credit card decision process and, more particularly, to a system for the optimization of a credit card decision process for individual transactions.

Reward credit cards have become very confusing, with rotating limits, variable reward rates, and complex rules. It is very difficult on a per-transaction basis to know which card to use, and nearly impossible to pick the best new card. Issuers of credit cards also struggle to create plans that are useful for their customers.

Currently, for card based solutions, the user has no discretion and no way to verify what rewards will be earned. Most web-based solutions only consider historic spending behavior when making recommendations, typically using manually entered estimates by users which is an error prone process, and do not optimize for the current decision making process.

As can be seen, there is a need for a system for the optimization of the credit card decision process that may be through a mobile application, cloud based service or the like and that provides current solutions in real time.

### SUMMARY OF THE INVENTION

In one aspect of the present invention, a system for recommending a preferred payment method comprises: a computer having a user interface; and a program product comprising machine-readable program code for causing, when executed, the computer to perform the following process steps: prompting a user to set up an account including personal information, payment information, and store information; receiving the personal information, payment information, and store information; initiating a request for location information; receiving a store choice; estimating a purchase amount based at least in part on the store choice and past purchase data; displaying a recommended payment method based at least in part on the purchase amount, the payment information, user preferences, and the store information; receiving a purchase quantity; and displaying a cash-back quantity based at least in part on the purchase quantity.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention; and

FIG. 2 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and method of recommending a preferred payment method for individual transactions that may include a software program. A user may set up an account and input personal information, payment information and store information for a potential purchase. A server database may store the inputted information. The user may select a store choice and receive an estimate of a purchase amount. The user may receive recommended payment method based at least on the purchase amount, the payment information, user preferences and the store information.

In certain embodiments, the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

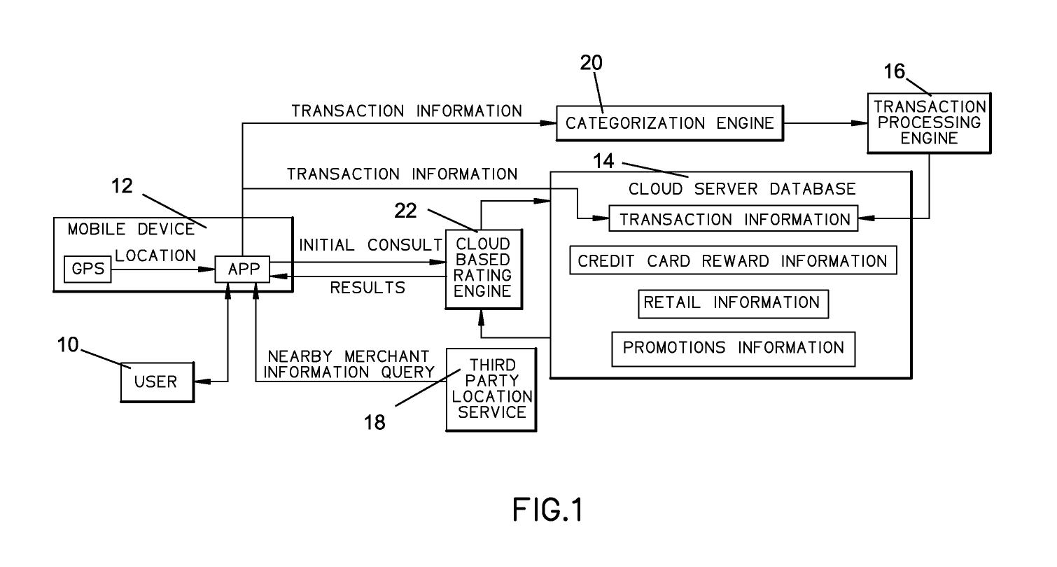

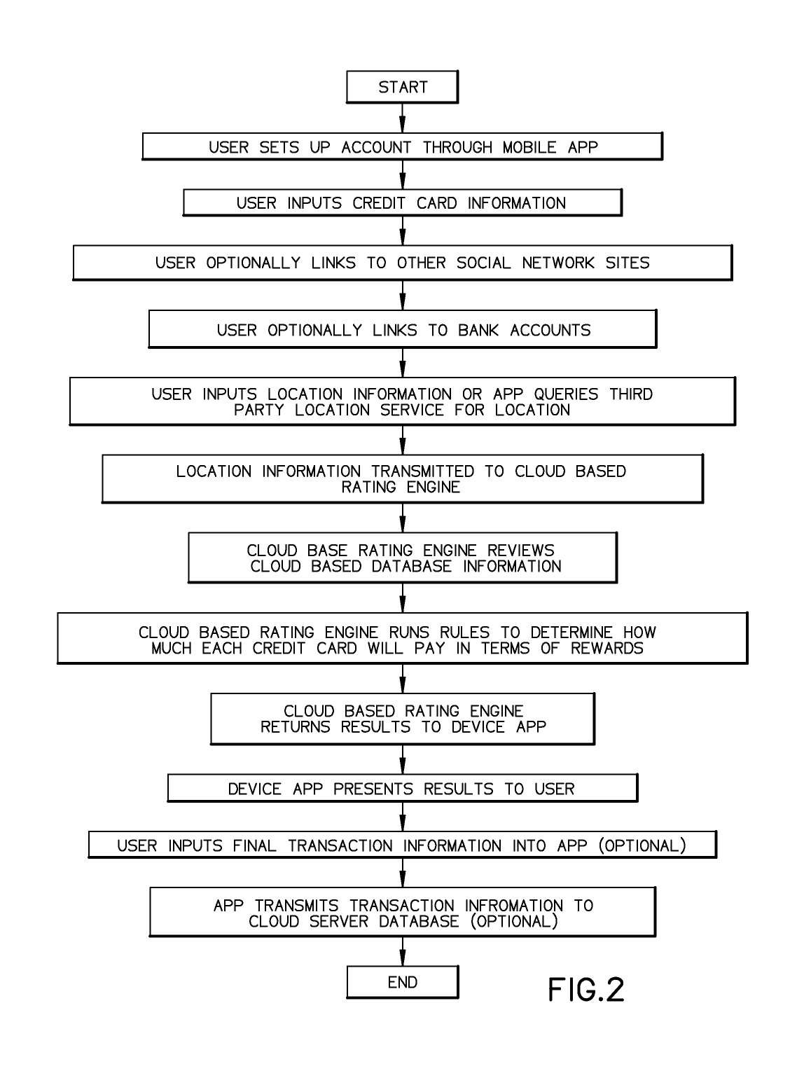

As is illustrated in FIGS. 1 and 2, the present invention may include a computer 12 such as a mobile device or web application, used by a user 10, connected to a server database 14, a categorization engine 20, a third party location service 18, a rating engine 22, and a transaction processing engine 16.

The server database 14 may include information on one or more users, credit cards, bank accounts, promotional information, and the like. The server database 14 may be cloud based. The third party location service 18 may be a part of a social network such as Facebook™, FourSquare™ and the like. These third party location services 18 may allow users 10 to share with friends on these social networks their current location or venue. The present invention may interact with these third party location services 18 without requiring the user 10 to initiate the application. The information from the third party location service 18 may bypass the mobile device 12. The rating engine 22 may be a service that is hosted on the cloud and parses a proposed transaction, categorizes it, and matches it against any rewards (promotional or standard) that may apply for the user 10 given the balances involved and the rules of each credit card the user 10 carries. The rating engine 22 may send and receive information to and from the server database 14. The rating engine 22 may also receive initial information from the mobile device 12 and send results to the mobile device 12. The transaction processing engine 16 may be cloud based as well. The transaction processing engine 16 may process one or more transactions that have been consummated. This may be initiated by the user 10 via the mobile device 12 or by an upload of an Intuit® file such as Quicken® or the like, or by integration with a third party transaction aggregation vendor. The categorization engine 20 may also be cloud based and may ingest transactions from multiple sources with various data specifications, and categorize the transaction in a canonical format that may be processed by the rating engine 22. Information from the categorization engine 20 may be sent to the transaction processing engine 16. The transaction processing engine 16 may send transaction information to the server database 14.

The mobile device 12 may initiate a direct request (e.g., user 10 selects a location based on GPS location that checks the third party location service 18 for nearby merchants). The mobile device 12 may be initiated by the third party location service 18, a check-in from a third party application. Once the mobile device 12 knows the location from the prior two steps, it will consult the rating engine 22. The rating engine 22 may review transactions in the server database 14 (which may have been populated manually by the mobile device 12 or automated with transaction processing engine 16). The mobile device 12 may display results to the user 10; the user 10 may confirm the purchase, amount, and card used. The mobile device 12 may then update the server database 14. The transaction processing engine 16 may be run periodically if the user 10 wishes to automate pulling in transactions from financial institutions. This will feed the server database 14 after running through the categorization engine 20. The categorization engine 20 may be used by all the processes to determine for a given transaction what categories the transaction represents. The categorization engine 20 may update data in the third party location service 18 to allow for the rating engine 22 to correctly determine what promotions and/or rewards apply.

Referring to FIG. 2, the user 10 may set up an account through an application on the mobile device 12. The user 10 may send information to the application as to the credit cards the user 10 has in their possession. In certain embodiments, the user 10 may link into social networks such as Facebook™, FourSquare™ and the like. In certain embodiments, the user 10 may also link their bank accounts. In alternate embodiments of the invention, this data may be provided on the user's behalf by a third party, such as a digital wallet or online checkout solution. Once the accounts and links have been set up, the user 10 may input their location information or the application may query the third party location service 18 for the location of the user 10. The user 10 may either check in on the social network or open the present application and pick from a series of nearby locations. The location information may then be transmitted to a cloud based rating engine 22. The cloud based rating engine 22 may be review the cloud based database information. The cloud based rating engine 22 may then run rules to determine how much each credit card will pay in terms of rewards. The cloud based rating engine 22 may then return results to the application. The results may include a determination based on how much money the user 10 may spend based on prior trips to that location, that corporate entity, or that category of purchase, such as lumber yards and the like. The application may then present the results to the user 10. In certain embodiments, the user 10 may then specify an exact amount to spend, and the system may return a refined estimate for what reward each credit card may pay. In certain embodiments, the user 10 may then input final transaction information into the application such as which credit card was used and how much the purchase was, which may then transmit the transaction information to the cloud server database 14.

In certain embodiments, the transactions may be linked in through the transaction processing engine 16. The application may provide reconciliation features for transactions that were manually entered. This reconciliation may be used to match manually entered transactions to those that were automatically imported into the system from other third party aggregation providers so that they are not counted twice. This transaction processing engine 16 allows for fuzzy logic in the cases where the amounts or categorization by the user 10 and by the third party are slightly different.

In certain embodiments, the application may be an Application Programming Interface (API) for Near Field Communication (NFC) or other payment options besides credit cards. For example, a user 10 may have a phone application that uses a NFC chip to process payments without requiring a card to be physically presented. In such cases, the invention may provide an API to allow for such applications to utilize the rating engine 22 to determine which card to use. NFC payment systems may also utilize the system to make automatic decisions for users. The application may integrate with a payment system such as Square™ or the like to further simplify the purchase process. The system may be able to integrate with the payment system process to initiate the recommendations whenever the user 10 makes a purchase, whether the application is open on their mobile device 12 or not.

A method of making the present invention may include the following. Build a server database 14 that may house all information about how credit card rewards are paid, for each institution. The database may also need to support categorization and other discriminators used by banks to provide rewards. In other words some promotions are for a period of time for purchases of gas up to a certain amount. The database needs to support this. The server database 14 may also support the storage of data about retailers to facilitate the recommendation process, including but not limited to data about what cards are accepted by a retailer, whether that retailer has online sales, and if a particular retailer is one location of a chain which may have special reward promotions. A series of algorithms that parse transaction data may be built (real time or historical from a transaction aggregator) and categorize those transactions according to the information required by the credit card database. Build an algorithm to accept proposed transactions and run the rules to determine how much each credit card will pay. Build a mobile application that may communicate with the server database 14 to present results for contemplated transactions. Build an interface to the third party location service 18. This allows user 10 to have options for triggering a purchase request. Build a reporting engine that may consider alternate cards, and payment options and recommend to users how much money they would have made if they owned the card in question.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer, For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for recommending a preferred payment method comprising:
a computer having a user interface; and
a program product comprising machine-readable program code for causing, when executed, the computer to perform the following process steps:
prompting a user to set up an account including personal information, payment information, and store information;
receiving the personal information, payment information, and store information;
initiating a request for location information;
receiving a store choice;
estimating a purchase amount based at least in part on the store choice and past purchase data;
displaying a recommended payment method based at least in part on the purchase amount, the payment information, user preferences, and the store information;
receiving a purchase quantity; and
displaying a cash-back quantity based at least in part on the purchase quantity.

2. The system of claim 1, wherein the computer accesses the server database by at least one of internet, extranet, intranet, host server, and internet cloud.

3. The system of claim 1, further comprising an application programming interface that provides the payment information.

4. The system of claim 1, wherein the initiating a request for location information is through initiating a check-in based at least in part on an initiation into a social media site.

5. The system of claim 1, wherein the initiating a request for location information is through prompting the user to choose from a list of nearby store locations.

6. The system of claim 1, wherein the payment information comprises a link to at least one bank account.

7. The system of claim 1, further comprising a step of providing final transaction information.

8. The system of claim 7, further comprising a step of transmitting final transaction information to the server database.

9. The system of claim 1, further comprising a step of presenting a report for simulations of which cards will enhance future rewards.
